(19) United States
(12) Patent Application Publication
(10) Pub. No.: US 2010/0227206 A1
(43) Pub. Date: Sep. 9, 2010

(54) SINGLE POINT BATTERY WATERING SYSTEM INCLUDING BATTERY REFILL VALVES INCORPORATING FLAME ARRESTORS

(75) Inventor: Daniel N. Campau, Ada, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Flow-Rite Controls, Ltd., Byron Center, MI (US)

(21) Appl. No.: 12/781,152

(22) Filed: May 17, 2010

Related U.S. Application Data
(63) Continuation of application No. 11/335,281, filed on Jan. 19, 2006, now abandoned.
(60) Provisional application No. 60/650,384, filed on Feb. 4, 2005.

(51) Int. Cl. H01M 2/36

(52) U.S. Cl. 429/74; 429/72

(57) ABSTRACT

The present invention is directed to a refill valve for use in single point battery watering systems for refilling wet cell batteries. The refill valve comprises a porous internal flame arrestor that is in the path of the liquid. Such a design is advantageous because it prevents the internal propagation of flames between battery cells through the battery watering system under dry conditions.

### BACKGROUND OF THE INVENTION

The present invention relates generally to single point battery watering systems. More particularly, the present invention relates to an improved refill valve for use in a single point battery watering system that prevents the internal propagation of flames between battery cells during refilling under dry conditions. The refill valve of the present invention performs this function by incorporating a porous internal flame arrestor in the water flow path within the valve.

Lead-acid batteries provide electrical energy by means of an electrochemical reaction that takes place within a plurality of cell units. Each cell unit in a battery contains positive lead dioxide (PbO₂) plates, negative lead (Pb) plates, and an electrolyte comprising sulfuric acid (H₂SO₄) and water (H₂O). Electrical energy is generated during discharging when sulfuric acid reacts with the lead in each plate, thereby forming lead sulfate (PbSO₄) and water. The overall reaction is as follows:

Pb+PbO₂+2 H₂SO₄→2 PbSO₄+2H₂O+Electrical energy

The reverse reaction takes place during re-charging, where the lead in each plate reacts with water and converts back to its original form. The re-charging reaction may also induce electrolysis, a two-step reaction where water is converted to hydrogen (H₂) and oxygen (O₂) gases:

2 H₂O→4H⁺+O₂+4 e⁻

4H⁺4e⁻→2 H₂

Re-charging and electrolysis lead to water loss in batteries. Additionally, battery cells lose water through evaporation if they are operated under dry conditions. Thus, the cells in many lead-acid batteries must be refilled with water on a regular basis.

The preferred method of refilling lead-acid batteries with water is by the use of single point watering (SPW) systems. Single point watering systems generally comprise a water feed tube that is connected to a plurality of refill valves through a tubing network. Each refill valve in the SPW system is mounted onto a single cell in the battery. The refill valves shut off automatically as soon as the fluid in the cell reaches a predetermined level.

During refilling, the H₂ and O₂ gases that were generated through electrolysis are displaced from the cells. These gases may subsequently ignite and initiate a flame. The flame may then propagate to other cells through the tubing network and cause a ruinous explosion. Thus, as preventive measures, many refill valves contain internal water traps and external flame arrestors.

External flame arrestors are usually located by vent ports outside the refill valves. They prevent the external propagation of flames by providing a hypoxic environment where the oxygen to sustain combustion is insufficient. However, external flame arrestors cannot prevent the propagation of flames once gases diffuse into the valves or tubing network. On the other hand, internal water traps provide such prevention means because they are located within refill valves. These traps use retained water in reservoirs to extinguish any generated flame or spark within the SPW system. The water in the traps also prevents intercellular gas diffusion.

Internal water traps function only when they are hydrated. Thus, they are not practical for use under dry conditions because the water in the traps may evaporate. Such dry conditions may include operation in hot weather or in batteries with elevated temperatures. The latter is a frequent situation in installations using new “fast charge” systems, where batteries are charged for short periods at a time and used frequently without a cool down period, thereby resulting in high service temperatures. An additional disadvantage of water traps is that mold or other contaminants may propagate in the traps and lead to fouling of the valves with consequent valve malfunction.

As apparent by the limitations in the prior art, there is an unmet need in preventing the internal propagation of flames between battery cells through single point watering systems. The present invention addresses this unmet need.

### SUMMARY OF THE INVENTION

The present invention is directed to a refill valve for use in single point battery watering systems for refilling wet cell batteries. The refill valve contains an internal fluid flow path from the input port of the valve to the output port of the valve. The refill valve utilizes an internal porous flame arrestor that is in the fluid flow path and does not require hydration for extinguishing flames. Such a design is advantageous because it prevents the internal propagation of flames between battery cells through the battery watering system under dry conditions.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of one embodiment of the refill valve of the present invention.

FIG. 2 is an exploded view which shows the individual components of the refill valve in FIG. 1.

FIG. 3 shows a simplified cross-sectional view of a refill valve useful in the practice of the present invention.

FIG. 4 shows a detailed cross-sectional view of the refill valve in FIG. 1.

### DETAILED DESCRIPTION OF THE PREFERRED EMBODIMENTS

Refill valves in single point battery watering systems that utilize a porous internal flame arrestor in the path of the water prevent the internal propagation of flames between battery cells through the tubing network. The use of such flame arrestors in the refill valves of SPW systems is advantageous because it prevents internal flame propagation without requiring frequent hydration. The use of such flame arrestors also eliminates the potential for valve malfunction arising from contaminants found in water traps. The internal flame arrestor of the present invention has the same flame arresting properties as the prior art external flame arrestors and flame arrestors in battery vent plugs. However, it was believed that this type of flame arrestor would be too restrictive to water flow to be used in the water flow path, and that the small pores would become clogged with waterborne debris. On the contrary, the internal flame arrestors of the present invention do not interfere substantially with water flow.

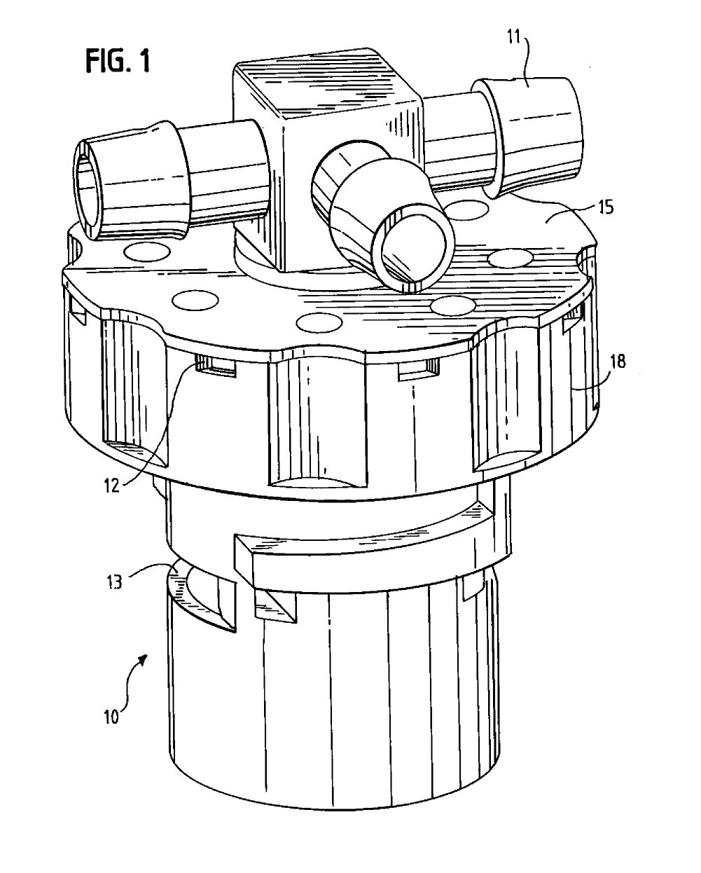

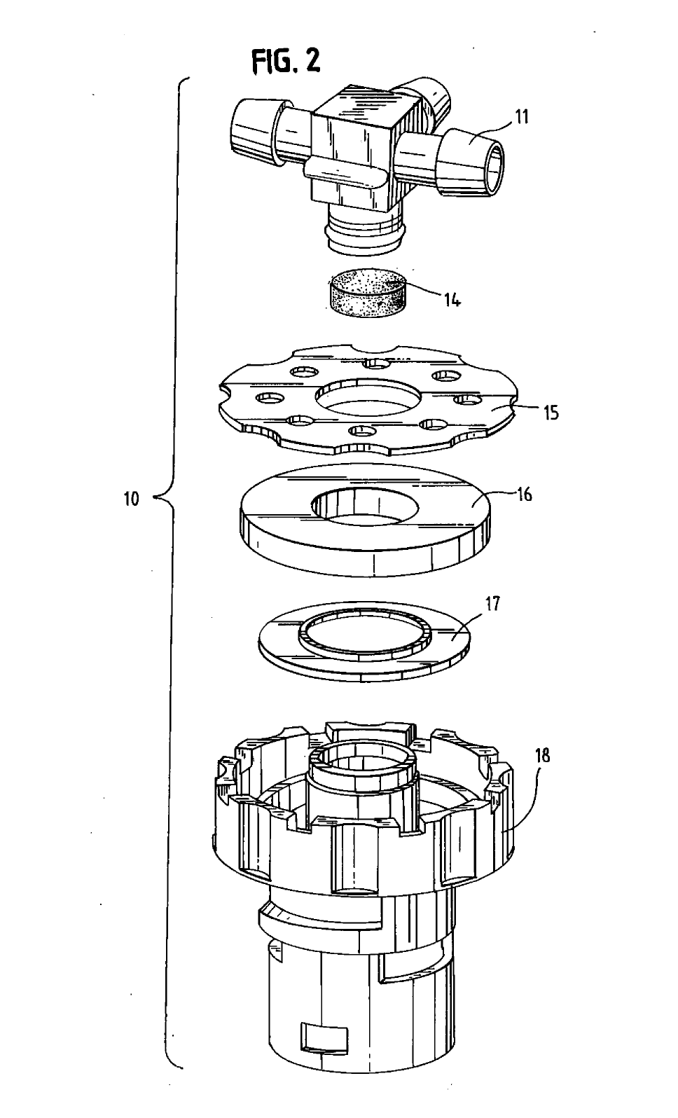

Turning now to FIG. 1, a refill valve 10 suitable for use in the present invention is shown. Refill valve 10 contains an internal fluid flow path from the input port of the valve to the output port of the valve. Fluids enter the refill valve at the proximal end through water inlet connector 11 and exit into battery cells at the distal end. The distal end comprises cell gas vent ports 13 for receiving gases that are displaced when the valve is inserted into the cells. These gases enter the refill valve through the ports and exit through cell gas outlet ports 12. The individual components of refill valve 10, including a porous internal flame arrestor 14 that is positioned within the fluid flow path, is shown in FIG. 2. It is also shown in FIG. 2 that the refill valve of the present invention may further comprise an external flame arrestor 16 for preventing external flame propagation.

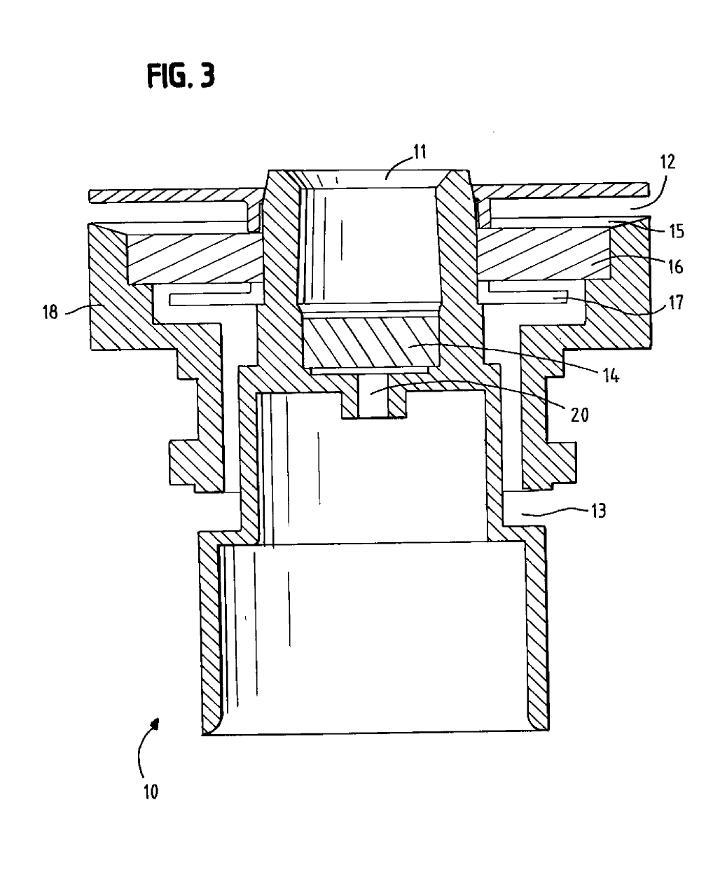

Turning now to FIG. 3, a cross-sectional view of a typical refill valve 10 is shown. It is shown that internal flame arrestor 14 is preferably located between water inlet connector 11 and inlet port 20. It is also shown that external flame arrestor 16 is preferably located in valve cap 18 and held in place by cover 15 and baffle 17. Such a location ensures that displaced gases that enter cell gas vent ports 13 are exposed to the external flame arrestor before they exit the valve through cell gas outlet ports 12.

Flame arrestor 14 is preferably a porous disc with a plurality of pores. Preferably, the pores are 90-120 microns in diameter, and more preferably about 120 microns in diameter. The thickness of flame arrestor 14 is preferably less than 1 inch, and more preferably about ⅛ inch in thickness. It is desirable that the pores comprise about 30-40% of the volume of internal flame arrestor 14. Internal flame arrestors with pore sizes, porous volumes and thicknesses outside the preferred ranges may also be used in the present invention, as long as they do not substantially block water flow. Likewise, flames arrestors with shapes other than discs (e.g., cubes, balls or cylinders) may be suitable for use in the present invention.

In one embodiment, internal flame arrestor 14 may be composed of one or more ceramic materials, such as aluminum oxide ceramics. In another embodiment, internal flame arrestor 14 may be comprised of a thermoplastic polymer, such as polyvinyl chloride, nylon, fluorocarbon, polyethylene, polyurethane, polystyrene, polypropylene, cellulosic resin, and acrylic resin.

An example of an internal flame arrestor that is suitable for use in the present invention is X-5666, a porous polypropylene flame arrestor by Porex Technologies Corporation. The flame arrestor is a disc with a diameter of ⅜ inch, a thickness of ⅛ inch, a pore size of about 120 microns, and a porous volume of about 30-40%. The Battery Flame Retardant Venting Systems Test SAE J1495 was used to demonstrate that X-5666 in the refill valves of a single point battery watering system inhibited flame propagation between cells in lead-acid batteries. Other tests have indicated that the internal flame arrestor did not show any signs of degradation or erosion after an equivalent five year of service life at high pressure flow.

Tests have also demonstrated that the X-5666 flame arrestor showed no signs of flow restriction. The water supplied in the tests was tap water, with an inline strainer having an 80 mesh screen, which is typical of industrial water supplies used with single point watering systems. The flow restriction due to this flame arrestor was found to be equivalent to a 1/16 diameter orifice, which is about the size of the refill valve inlet port 20 shown in FIG. 3. In addition, the cumulative cross-sectional area of the pores on the internal flame arrestor was estimated to be about 10 times higher than the cross-sectional area of the inlet port 20.

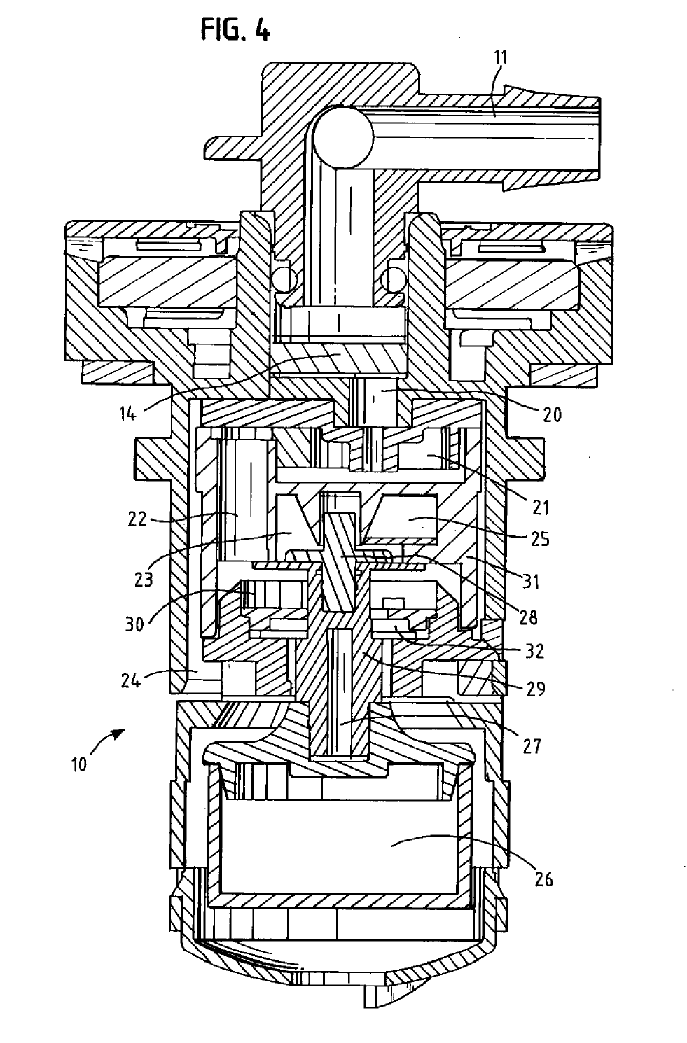

A more detailed cross-sectional view of refill valve 10 is shown in FIG. 4. It is shown that fluids enter refill valves through inlet connector 11. The fluids then flow through internal flame arrestor 14 and inlet port 20 into reservoir 21, which serves as an internal water trap. Once filled, the fluids in reservoir 21 flows into chamber 22. The refill valve shown in FIG. 4 is in a closed position as occurs when the cells in the battery are filled with fluid. A displacer 26 is directly connected to stem 27 of a valve support assembly. When fluid level is low, the displacer rests in its reset position, which opens both upper valve 28 and lower valve 29. In this orientation, water is free to flow from chamber 22 to upper and lower valve ports 23 and 30. The water then flows into the battery cells through opening 24. Upper valve port 23 also provides another opening 25 that allows water flow to the cells. When the electrolyte level rises sufficiently to lift the displacer 26, the upper and lower valves are pressed against their respective seats, 31 and 32, by the pressure of the supply line, blocking further flow into the cell. Such an assembly is described in more detail in U.S. Pat No. 6,227,229 and incorporated into this application by reference.

Though only a single internal flame arrestor is shown in FIGS. 2-4, a plurality of flame arrestors may also be used in another embodiment of the present invention, as long as the flame arrestors do not interfere substantially with water flow.

The refill valves of the present invention may also be used with different SPW systems. In one embodiment, the SPW system may comprise a plurality of refill valves 10 with water inlet connectors 11, a single water source, and a tubing network that supplies water to the refill valves through the inlet connectors. Examples of such SPW systems and variations thereof are described in detail in U.S. Pat. Nos. 5,832,946, 5,284,176, 5,482,794, and 5,453,334. The disclosures of these patents are hereby incorporated by reference.

Single point battery watering systems with rigid manifold arrangements may also be used with the refill valves of the present invention. Such SPW systems comprise several rigid manifolds, where each manifold houses a plurality of refill valves. Each manifold also contains a longitudinal water feed tube that places the housed refill valves in fluid communication with one another. In addition, a tubing network places the manifolds in fluid communication with each other and with a water supply tube. SPW systems with such rigid manifold arrangements are disclosed in U.S. Pat. No. 6,782,913, U.S. Pat. No. 6,644,338, and U.S. Pat. App. No. 2004/0161661. These disclosures are also incorporated into this application by reference.

The battery used with the SPW systems of the present invention may be any wet cell battery, preferably a wet cell lead-acid battery, and more preferably a deep cycle lead-acid battery used in fast-charge installations. Though the refill valves of the present invention are preferably used with SPW systems to refill water in battery cells, they may also be used to supply cells with other fluids, such as electrolytes.

It will be evident that there are numerous embodiments of the present invention which, while not expressly described above, are clearly within the scope and spirit of the invention. The above description is therefore intended to be exemplary only and the scope of the invention is to be determined solely by the appended claims.

1. A refill valve for use in single point battery watering systems to supply battery cells with a fluid comprising:
a valve structure defining an internal fluid flow path from the input port of the valve to the output port of the valve; and
a porous flame arrestor positioned within said flow path, wherein the flame arrestor prevents the internal propagation of the flame between cells of the battery.

2. The refill valve of claim 1 wherein the flame arrestor is fabricated from a material selected from the group consisting of polyvinyl chloride, fluorocarbon, polyethylene, polyolefin, polyurethane, polystyrene, polypropylene, cellulosic resin, and acrylic resin.

3. The refill valve of claim 1 wherein the flame arrestor comprises a ceramic material.

4. The refill valve of claim 1 wherein the internal flame arrestor has a pore size of about 120 microns.

5. The refill valve of claim 1 wherein the internal flame arrestor has a thickness of about ⅛ inch.

6. The refill valve of claim 1 further comprising an external flame arrestor.

7. The refill valve of claim 1 further comprising an internal water trap.

8. The refill valve of claim 1 further comprising a control device to cause the refill valve to shut off at a predetermined fluid level.
